(19) United States
(12) Patent Application Publication
(10) Pub. No.: US 2018/0041460 A1
(43) Pub. Date: Feb. 8, 2018

(54) Aggregation in a Communication System or Service

(71) Applicant: Microsoft Technology Licensing, LLC, Redmond, WA (US)

(72) Inventors: Salil Das, Hyderabad (IN); Rajiv Kumar, Hyderabad (IN); Deepak Pratinidhi, Hyderabad (IN); Vinay Kumar, Hyderabad (IN); Rakesh Midha, Hyderabad (IN); Arun Rajappa, Hyderabad (IN); Jayawant Tewari, Hyderabad (IN); Shashank Agarwal, Hyderabad (IN); Harsh V. Singh, Hyderabad (IN); Teekam Chand Goyal, Hyderabad (IN); Prashant Gupta, Hyderabad (IN)

(73) Assignee: Microsoft Technology Licensing, LLC, Redmond, WA (US)

(21) Appl. No.: 15/397,227

(22) Filed: Jan. 3, 2017

(30) Foreign Application Priority Data
Aug. 4, 2016 (IN) 201641026623

(51) Int. Cl. H04L 12/58; H04L 12/761; H04L 29/12

(52) U.S. Cl. CPC H04L 51/28; H04L 51/04; H04L 61/2069; H04L 51/16; H04L 45/16; H04L 61/1564

(57) ABSTRACT

A system and method for aggregating user response data in a communication system such as an instant messaging (IM system). Aggregation is performed according to a hierarchical group addressing structure into which users are arranged. Data may be input, output and distributed in a structured data format. Aggregating information comprises collating, in each group in the hierarchical group addressing structure, information contained in responses from individual users in that group. Aggregating said information may further comprise collating, for each group in the hierarchical group addressing structure, information contained in responses from all child groups subordinate to that group. Because the grouping structure for addressing or routing is pre-existing, no additional grouping or categorising of individuals or responses is required.

### RELATED APPLICATIONS

This application claims priority under 35 USC 119 or 365 to Indian Patent Application No. 201641026623 filed Aug. 4, 2016, the disclosure of which is hereby incorporated by reference in its entirety.

### BACKGROUND

The present invention relates to network communication, and in particular instant messaging.

Instant messaging (IM) is a communication method and set of technologies which offers real time text transmission between two or more participants over a network, such as the internet. Instant messaging differs from other technologies such as email due to the perceived quasi-synchrony of the communications by the users. More advanced instant messaging can add file transfer, clickable hyperlinks, Voice over IP, or video chat.

IM allows effective and efficient communication, usually allowing immediate receipt of acknowledgment or reply. However, IM is not necessarily supported by transaction control. It is usually possible to save a text conversation for later reference. Instant messages are often logged in a local message history, making it similar to the persistent nature of emails.

A popular feature of instant messaging is groups, whereby two or more users or clients can become members of an identifiable group. Messages can then be sent to an identified group, and are delivered or published to all the members of that group.

### SUMMARY

It is identified herein that the functionality of instant messaging is limited, and it is desirable to provide improved functionality, particularly, but not exclusively, where very large numbers of users are involved.

Accordingly, in a first aspect of the invention there is provided a method comprising distributing a structured data format message to a plurality of users of a communications service, according to a hierarchical group addressing structure into which said users are arranged; receiving a plurality of responses to said message from at least some of said plurality of users, said responses including information input by the respective users according to said structured data format; aggregating said information using said hierarchical group addressing structure; and outputting said aggregated information to at least one user of the communications service.

In this way, large numbers of responses, for example hundreds, or thousands, or potentially millions of responses can be handled and viewed in a more efficient and manageable way. In examples the method is implemented in an instant messaging (IM) system in which users are organised into groups, and groups may have other groups as members in a hierarchical or tiered structure, which also helps accommodate very large numbers of users. The hierarchical group structure is primarily used for routing messages between users, but here it can additionally be used to aggregate data input by users. In examples therefore, aggregation of user input information is performed according to the delivery channel or routing mechanism over which that information is communicated or exchanged. This reduces the need for separate aggregation at a receiver side receiving all information individually, and may allow reduced processing and network traffic requirements.

In embodiments the method may further comprise receiving said structured data format message from a first user of the communication service, said message being addressed to at least one group of said hierarchical group addressing structure. This allows a user to easily send the message to a desired set of recipients taking advantage of the hierarchical grouping. For example, distributing said structured data format message may comprise determining all child groups which are subordinate in said hierarchical structure to the or each group to which said structured data format message is addressed; and routing said message to all members of groups to which said message is addressed, and all determined child groups. Such cascading allows very large numbers of users to be addressed indirectly, using grouping structures, and cascading messages down such structures, from parent group to child group.

In embodiments, aggregating said information comprises collating, in each group in the hierarchical group addressing structure, information contained in responses from individual users in that group. Aggregating said information may further comprise collating, for each group in the hierarchical group addressing structure, information contained in responses from all child groups subordinate to that group.

Thus group aggregation can be performed for information received from individual members of a group for each group. Aggregation can also be performed on aggregated information of sub groups, or child groups with parent groups. In this way, aggregation can be performed “bottom up” with aggregations of lower level information being successively combined with other aggregations or individual information at a higher level, thus reducing the number of individual data items at higher levels of grouping, and easing processing burden. Furthermore, because the grouping structure for addressing or routing is pre-existing, no additional grouping or categorising of individuals or responses is required.

A sender of a message may define the data format structure in examples. This may be from a template or set of template structures for example, and may constrain user entered information in response to the message, for example defining a limited set of possible responses in a multiple choice format. Such a structured data message may be routed to recipients in a conventional way in the communication system such as an IM system, however the display of such massages and responses may be treated differently in some aspects. Structures format messages may include metadata controlling and varying how the message is displayed, or how responses, and/or data input by users included in such responses should be handled for example.

In the example of a poll message, having a limited number of possible answers, aggregating typically comprises summing responses of each possible answer. However, other functions such as a median or mean could be used, possibly combining more than one answer type, if for example recipients were polled to provide a score from 1 to 5. More generally, types of message other than polling are possible, and the structured data format could be embodied in an order form for example, or an approval request, such as a holiday request. These will typically constrain responses to certain fields or formats, but even if a free response is permitted, aggregation is still possible based on the number of responses for example, which can be summed or averaged in examples.

The aggregated information is output to the sender of the original message in embodiments, however requests may be received from other users, such requests typically indicating a target group or groups for which aggregated data is desired, and such aggregated information corresponding to information contained in responses from said target group or groups can be output to such other users. In other embodiments, a request for aggregated information from a user or users of the communication service may be received, and aggregated information corresponding to information contained in responses from the group to which said user or users belong, and all child groups subordinate to that group, is output.

In embodiments, the output is provided as a message in the structured data format. The output format may be different to, or a variation of, that viewed by recipients of the original message. The viewed format may for example depend on metadata contained within the message. In embodiments, an output message, providing aggregated data output, may be updated. For example, the output may be updated periodically, or when new information is provided to the system by a user response, substantially in real time.

Responses in the structured data format can be distinguished from other message types, and treated and routed differently. In examples, such responses are not distributed to other users in the way that regular messages would be, according to standard routing rules. Instead, the data may be extracted, stored, and aggregated as described herein, and the aggregated data is output in a defined structured format, which may be a single message in examples. Thus where very large numbers of users are involved, the number of individual messages in the system can be reduced, and presentation in a single message can provide a more efficient form of data communication, reducing traffic and processing in the system.

In embodiments, the hierarchical group addressing structure includes at least a first group of users and a second group of users, said second group being a member of said first group, such that messages addressed to the first group are routed also to the second group. Furthermore, in examples, messages addressed to the second group are not routed to the first group.

According to a further aspect of the invention there is provided a communications system comprising one or more messaging servers; one or more user terminal devices in communication with said one or more messaging servers; a directory storing group information of groups used to route messages to multiple users, wherein said directory includes at least one child group which is a member of another parent group; a data store, containing data representing user input to messages at said terminal devices and sent over said communications system; and an aggregation engine adapted to aggregate data stored in said data store according to group information stored in said directory; wherein said one or more messaging servers is adapted to route messages to terminal devices based on said group information, and to forward aggregated data output by said aggregation engine to at least one terminal device.

In embodiments, the one or more messaging servers is adapted to route messages addressed a parent group also to a child group. In further embodiments, the one or more messaging servers is adapted not to route messages addressed a child group to a corresponding parent group.

The invention extends to methods, apparatus and/or use substantially as herein described with reference to the accompanying drawings.

Any feature in one aspect of the invention may be applied to other aspects of the invention, in any appropriate combination. In particular, features of method aspects may be applied to apparatus aspects, and vice versa.

Furthermore, features implemented in hardware may generally be implemented in software, and vice versa. Any reference to software and hardware features herein should be construed accordingly.

### BRIEF DESCRIPTION OF THE DRAWINGS

To assist understanding of the present disclosure and to show how embodiments may be put in effect, reference is made by way of example to the accompanying drawings in which:

FIG. 1 is a schematic of a communication system,

FIG. 2 shows a functional schematic of an example user terminal suitable for use in the communication system of FIG. 1,

FIG. 3 is message sequence chart illustrating a basic example of instant messaging,

FIG. 4 illustrates tiered or nested user groups,

FIGS. 5 and 6 show flow of message routing in a tiered or nested structure,

FIGS. 7a and 7b illustrate a graphical user display for an example IM system,

FIG. 8 illustrates a further graphical user display for an example IM system,

FIG. 9 illustrates functional components for providing an example IM service or system,

FIGS. 10 to 12 show data flows for an aggregation in a communications system,

FIG. 13 shows an example framework architecture for aggregation in a messaging system,

FIGS. 14 and 15 illustrate an example data aggregation by address group structure.

### DETAILED DESCRIPTION OF EMBODIMENTS

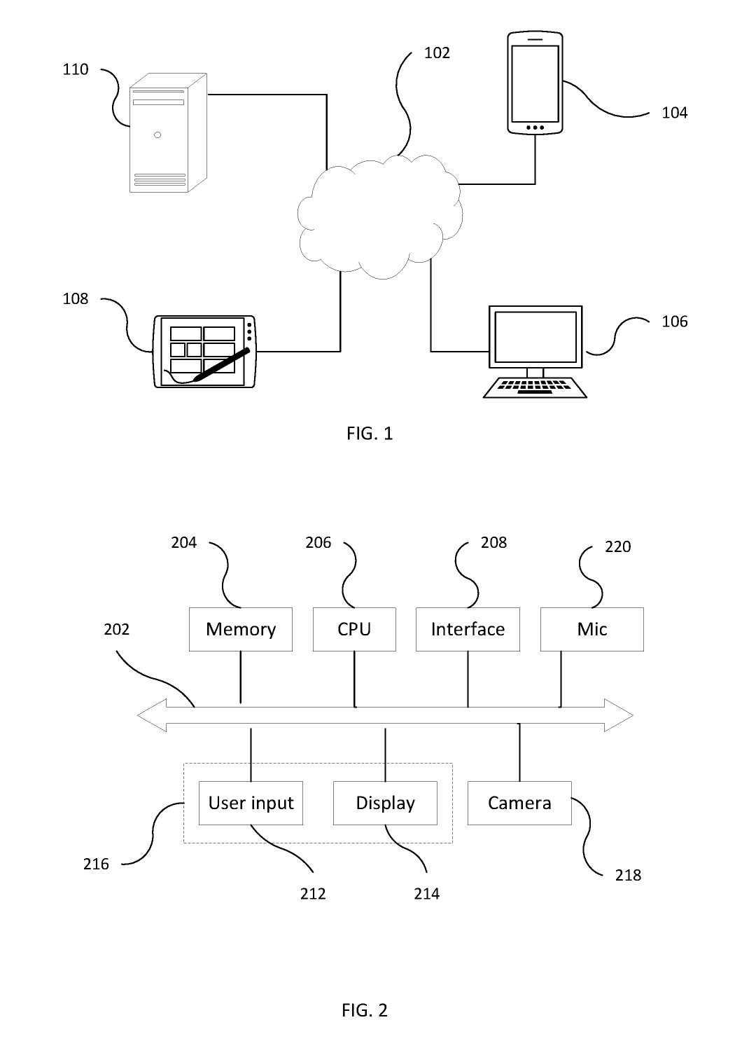

FIG. 1 illustrates an example of a communication system in which an instant messaging system and method can be implemented. A network 102 enables communication and data exchange between user terminals or devices 104-110 which are connected to the network via wired or wireless connection. The network may be a single network, or composed of one or more constituent networks. For example, the network may comprise a wide areas network such as the internet. Alternatively or additionally, the network 102 may comprise a wireless local area network (WLAN), a wired or wireless private intranet (such as within a company or an academic or state institution), and/or the data channel of a mobile cellular network. In an embodiment a device is able to access the internet via a mobile cellular network.

A wide variety of terminal or device types are possible, including a smartphone 104, a laptop or desktop computer 106, a tablet device 108 and a server 110. The server may in some cases act as a network manager device, controlling communication and data exchange between other devices on the network, however network management is not always necessary, such as for some peer to peer protocols.

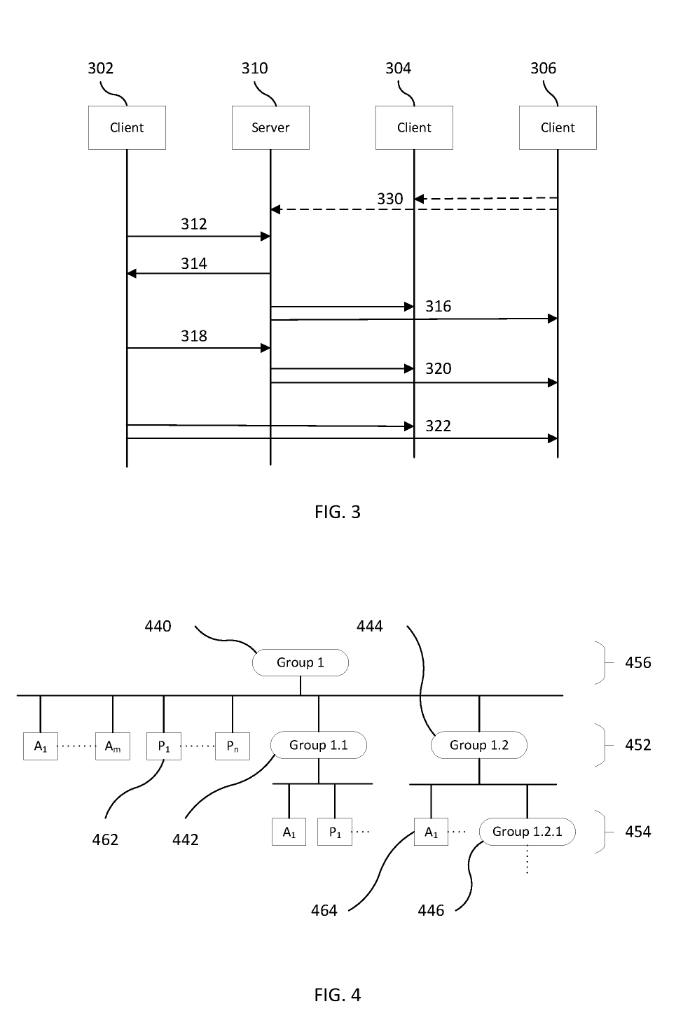

A functional schematic of an example user terminal suitable for use in the communication system of FIG. 1 for example, is shown in FIG. 2.

A bus 202 connects components including a non-volatile memory 204, and a processor such as CPU 206. The bus 202 is also in communication with a network interface 208, which can provide outputs and receive inputs from an external network such as a mobile cellular network or the internet for example, suitable for communicating with other user terminals. Also connected to the bus is a user input module 212, which may comprise a pointing device such as a mouse or touchpad, and a display 214, such as an LCD or LED or OLED display panel. The display 214 and input module 212 can be integrated into a single device, such as a touchscreen, as indicated by dashed box 216.

Further input/output devices may also be provided, for receiving audio and/or video information from the user, such as a microphone 220 and a camera 218. Furthermore, the i/o devices comprise one or more user input devices enabling applications to receive user inputs and selections from the user. An operating system running on the user terminal is an end-user operating system, i.e. designed for user terminals to provide an interface to the end user, to present information from applications to a user through a graphical user interface presented on a display 214, and to receive back inputs to applications from the user through one or more user input devices.

Programs such as an operating system, a web browser, an instant messaging application, and other applications are stored memory in 204 for example can be executed or run by the CPU, to thereby perform the various operations attributed to them. In the case of an IM service, a client is generally provided as separately installed piece of software such as an app, or a browser-based client. The storage on which the operating system, instant messaging application and other application(s) are stored may comprise any one or more storage media implemented in one or more memory units. E.g. the storage means may comprise an electronic storage medium such as an EEPROM (or “flash” memory) and/or a magnetic storage medium such as a hard disk. Note also that the term “processor” as used herein does not exclude that the processor may comprise multiple processing units.

The network interface 208 enables the user terminal to connect to a packet-based network possibly comprising one or more constituent networks. E.g. in embodiments the network may comprises a wide area internetwork such as that commonly referred to as the Internet. Alternatively or additionally, the network 102 may comprise a wireless local area network (WLAN), a wired or wireless private intranet (such as within a company or an academic or state institution), and/or the data channel of a mobile cellular network. To connect to such a network, the network interface 208 may comprise any of a variety of possible wired or wireless means as will be familiar to a person skilled in the art. For example, if the network 102 comprises the Internet, the network interface 208 may comprise a wired modem configured to connect to the Internet via a wired connection such as a PSTN phone socket or cable or fibre line, or via an Ethernet connection and a local wired network. Or alternatively the network interface 208 may comprise a wireless interface for connecting to the Internet via a wireless access point or wireless router and a local (short-range) wireless access technology such as Wi-Fi, or a mobile cellular interface for connecting to the Internet via a mobile cellular network.

The connection to the network via the network interface 208 allows applications running on the user terminal to conduct communications over the network. User terminals such as that described with reference to FIG. 2 may therefore be adapted to send text and/or audio and/or video data, over a network such as that illustrated in FIG. 1 using a variety of communications protocols/codecs, optionally in substantially real time.

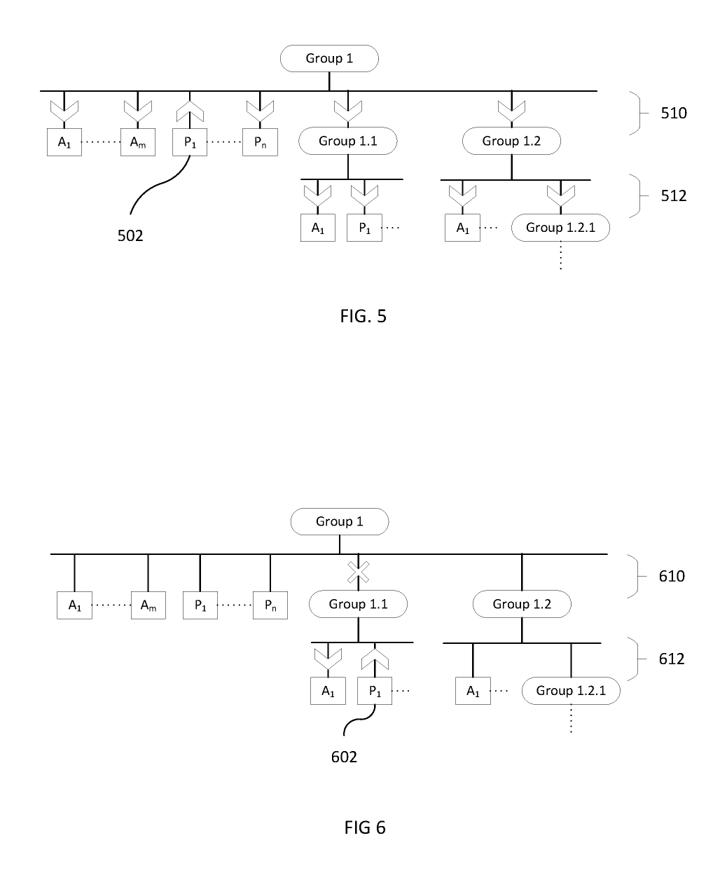

FIG. 3 is message sequence chart illustrating a basic example of instant messaging between a plurality of clients. 302, 304, 306. As noted, a client may be a separately installed piece of software, or a browser-based client operating on a user terminal or device, such as mobile phone, tablet, laptop computer or desktop computer.

When a sending user logs in, the corresponding client 302 sends (312) to a server 310 connection info such as IP address and port, and contacts information including details of any groups the sending user is a member of, if this is not already stored at the server. In this example clients 304 and 306 correspond to users who are contacts of the sending client. The server can check which users from amongst the contact information are logged on or online, and can report back (314) to the client 302. Client 302 can update a display to indicate the status of contacts (e.g. whether they are online or not, or the last time they were logged on or online). The server may notify (316) clients corresponding to the contacts information that client 302 is logged in, and optionally provide the connection information of client 302.

The sending user wishes to send an IM to a group, which includes clients 304 and 306. The message is sent (318) to the server. The server can analyse the message to determine the intended recipients, by receiving the name or ID of the group, and looking up members of that group in stored or received contact information and their connection information, and can forward the message appropriately (320).

In the above described method, a hub-spoke architecture is used, with messaged passing between clients via a server, however a peer to peer architecture is a possible alternative. In a peer to peer system, at 314 the server can also provide connection information (e.g. IP address and port) of contacts who are logged in or online (having been notified of such information from the respective clients, shown dashed line as 330). In this way the client 302 is able to send a message directly (322) to clients 304 and 306, as it has the necessary connection information to access them without the need for a routing intermediary. It is noted that even in a peer to peer session, a server is typically employed to administrate connection information between clients.

Peer to peer architecture is generally more useful for communication where two or more users are connected for a session, such as for a voice call or videoconference for example. A server client, or spoke hub architecture may be more suitable to a text based communication system such as instant messaging.

The above example uses a group arrangement, whereby two or more, or typically three or more users are organised together in a group, having a particular name or identifier. A message can be addressed to the name or identifier of the group, and control logic at the client or server can look up the names and/or addresses of the members of the group, so that the message can be forwarded (i.e. duplicated) to the relevant clients. A group may contain one or more administrators, or admins, who are able to control group properties, such as adding or removing members of the group, or renaming the group for example.

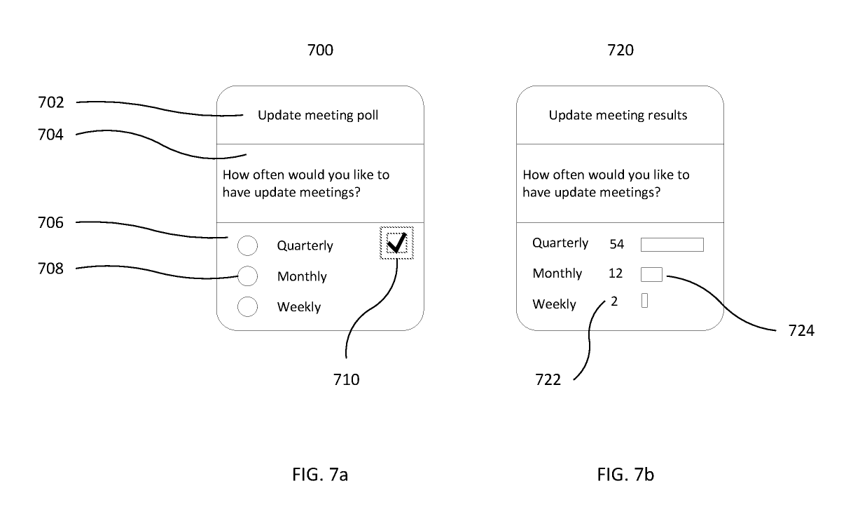

FIG. 4 illustrates how, in examples, a group may contain one or more groups, in a nested or hierarchical structure. It will be seen that a group can have a member of two types—individual or (sub-) group.

Group 1 440, contains a number of user members, some of whom may be administrator members A₁ to Aₘ, and some of whom may be regular members P₁ to Pₙ. Also included as a member of Group 1, is a sub-group, or child group, Group 1.1 442. This child group includes an admin member A₁, and one or more ordinary members P₁ . . . Group 1.1 contains no further child groups.

Group 1 also contains another child group, Group 1.2, indicated by reference numeral 444. This group again includes some individual members, and includes a further sub- or child group, Group 1.2.1 446. Group 1.2.1 may have individual user members, and could have further sub-groups.

Thus it can be seen that multiple tiers or hierarchical levels are established, by a group structure which can support child or sub-groups. A first level indicated by numeral 452 includes user members of Group 1. In some examples names or identifiers (shown as lozenge or oval shapes to distinguish from individual user members) of Groups 1.1 and 1.2 (but not individual members of these groups) can be considered as existing at this level. A second, lower, level 454 includes members of Group 1.1 and members of Group 1.2, and it can be considered that a name or identifier of Group 1.2.1 exists at this level also. The name or identifier of Group 1 can be considered as a top or zeroth level 456.

A parent group may have more than one child group, as illustrated in FIG. 4, however it is also possible for a child group to belong to more than one parent group. Furthermore, an individual user or client can belong to multiple groups, at multiple levels, as required. For example, regular member 462 in Group 1 may be the same user as admin member 464 in Group 1.2. Therefore, groups may overlap both inter and intra level in some cases. It is also noted that a group may have only other (sub-) groups as members, and no individual members.

Users will typically only see the groups, for example listed in a summary view, that they are directly part of but can preferably view the current standing of the group on details view so that they can view the parent groups and sub-groups for the group that they are member of.

In a simple (flat) group structure with no nested or sub-groups, routing or sending policy or logic is typically simple in that a message sent to a group is sent or made available to all members of that group. If a member of that group replies to the message, that reply is also sent or made available to all members of the group. In other words, all messages sent to a group are made available or delivered to all members of that group always.

With a group structure which includes nested groups, it has been found to be beneficial to establish a more sophisticated message routing policy.

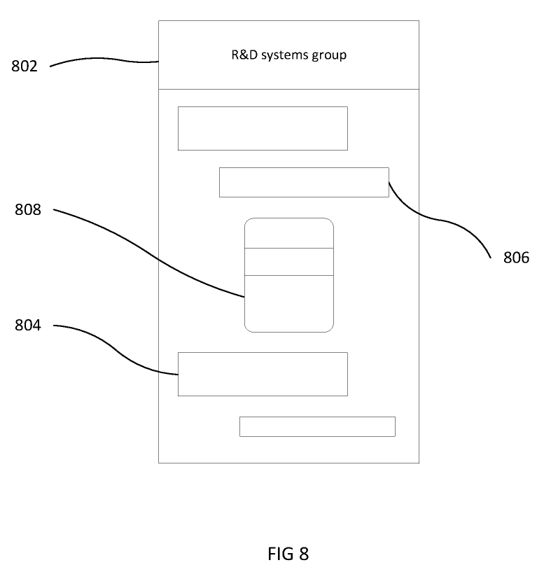

FIG. 5 illustrates an example message routing policy for nested groups.

A first feature of an example routing policy is that all messages sent in parent groups are routed to all child groups that belong to that parent group, and downwards to all members of child groups in the layer below.

This can be seen by considering an example message sent by user 502 of FIG. 5. The message is addressed to Group 1, and is routed to all the members of group as shown by chevrons 510 at a first level. This includes all individual members and Groups 1.1 and 1.2 since these are also members of Group 1. The message is then routed to all the members of child groups 1.1 and 1.2, as indicated by chevrons 512 at a second level. Group 1.2.1 is a member of group 1.2, and therefore the message is routed to this group and all its members also.

A second feature of an example routing policy is that messages sent in a child group are not routed upwards to parent groups or their members.

Considering FIG. 6, a message sent by user 602 is routed to all other members of Group 1.1, but does not get routed upwards to Group 1, as indicated by an “X” symbol. For example, the message sent by user 602 may be a reply to the message sent by user 502 in FIG. 5.

It can be seen that these two features effect a “cascaded” or “top down only” communication system. Such a system is asymmetrical when considering replies or responses—a reply to a group message will not necessarily be routed to all the recipients of the original group message. Instead, the reply will only be promulgated to members of the group or groups to which the replying user belongs, and cascaded downwards.

A third feature of an example routing policy is that circular dependency is recognized by the system, and messages are terminated at an appropriate point to avoid flooding.

In examples, a circular nesting of groups may be possible, which would result in messages being routed continuously. In order to prevent this, the system can identify when a message has been routed to all valid recipients once, and terminates further routing.

As illustrated in FIGS. 4 to 6, there may be two types of individual members (in addition to group members) of a group—regular members and administrators with higher privileges. In examples, only administrators of a group can add members to that group, including other groups. Administrators can also remove members of a group, including subgroups, however members may be able to leave a group without the permission of an administrator. An administrator of a group, acting on behalf of the whole group, may be able to leave a higher group of which it is a member.

An administrator of a group may not be able to join that group, as a child group, to another group, as this should be performed by an administrator of that other group. However, a request to join could be lodged, and could then be accepted (or not) by an administrator of that other group.

An administrator of a group at a lower, or child level, should be able to view all of the parent groups to which that group belongs (including grandparent groups and great grandparent groups etc . . . ), but may not be able to view individual members of parent groups at higher levels.

Typically users in an IM system, either with regular “flat” groups, or employing a hierarchy of groups, are identified by a unique identifier. The unique identifier may be assigned by the instant messaging system/network in examples. However, an identifier such as a telephone number, for example a mobile or cellular telephone number can be used, which is registered with a communications network other than the instant messaging system. In examples, one or more further identifiers can additionally be assigned to a user by the system/network, and linked or indexed to a telephone number if desired.

As well as plain text messages, and IM service or system may support more sophisticated data exchanges between users or subscribers. “Container cards” is a term used herein to describe a mechanism of interacting with byte sized structured data in a multi-user collaborative system like group chat. Container cards allow viewing, authoring, collecting and enriching in different systems and services such as IM/real time chat systems, social networking systems etc. Container cards may be implemented as mini applications or apps; they may be mobile user interfaces (MUIs) or data templates. Container cards can provide a convenient way to gather and view information from a very large number of users (possibly hundreds, thousands or tens or hundreds of thousands) users

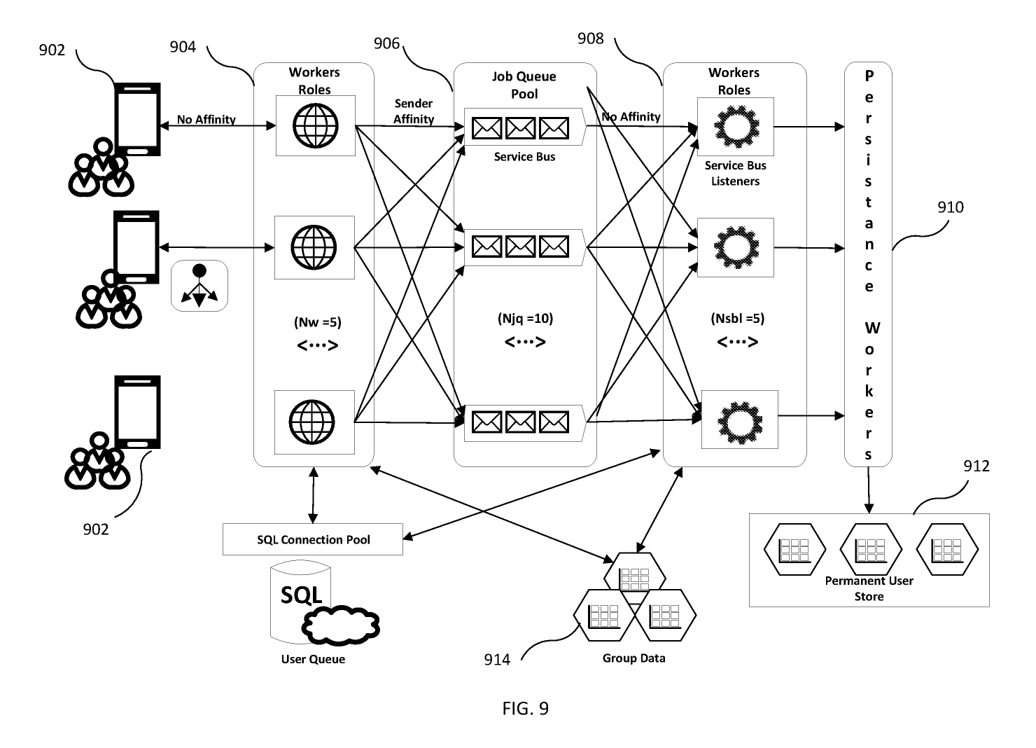

FIGS. 7a and 7b show container cards in the form of a message to allow a user to poll other users and view summarised results. The container cards define a structured data format for exchanging information with other users.

Container card 700 viewed by a recipient has a header section 702 allowing a user defined title to be included. A main display area 704 includes text in this example, but may also have pictures, graphs or videos. This example is in the context of a polling exercise, and the main body includes a question to be asked to addressees of the message. Section 706 is an action section which contains controls to allow a recipient of the message to reply. Here three defined responses are shown, and control buttons 708 allow a recipient to select one of the three possible answers. A graphic or icon 710 shows a user which answer has been selected.

Container card 720 is similar to Card 700, but shows the aggregated results derived from user responses. For example, card 720 may be viewed by the sender or originator of the card 700. For each of the three choices provided to recipients, numbers 722 corresponding to the sum of responses are shown. Optionally a chart or graphic 724 provides a visual representation of the results also.

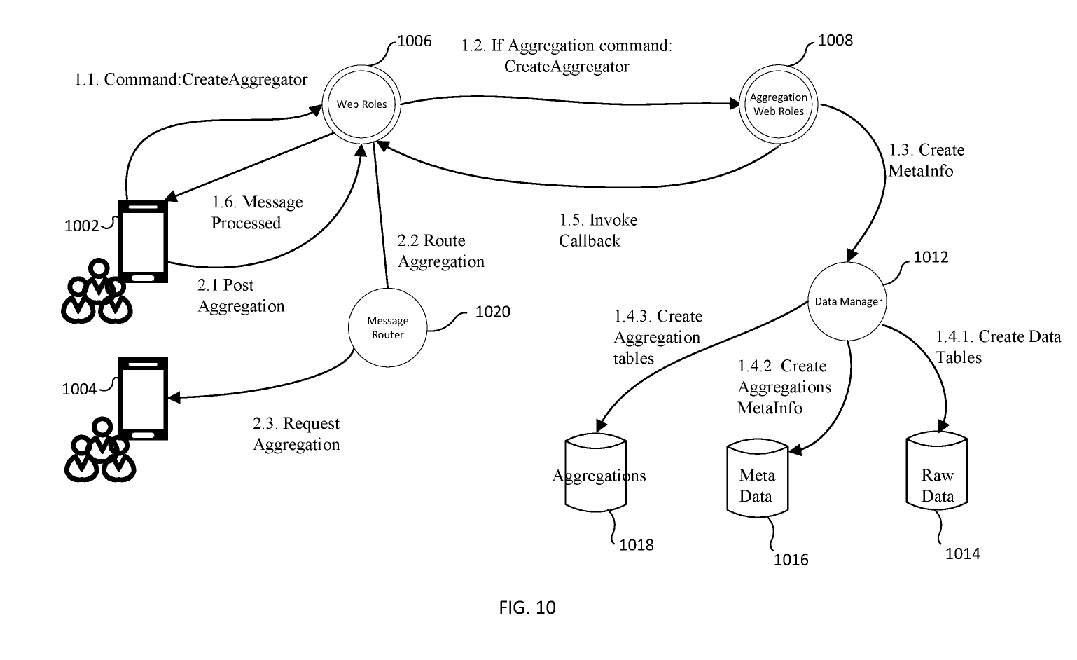

FIG. 8 shows a user display which may be provided on a user terminal, showing a series of sent and received messages as part of a group chat, including a container card.

Header 802 shows the name of the group, which is “R&D systems group” here. In the main part of the display, received messages such as message 804 are displayed towards the left, and sent messages such as 806 are displayed towards the right.

A container card 808 is shown in the message feed, and may be the poll 700 or results 720 container card of FIG. 7 for example

Typically messages in such a display are shown in chronological order, with the most recent at the top. In this case however, a container card may be promoted to a higher order, even if they were received at a later time than messages shown below them. Additionally or alternatively such container cards may “stick” to the top of the display, with later received messages being displayed below.

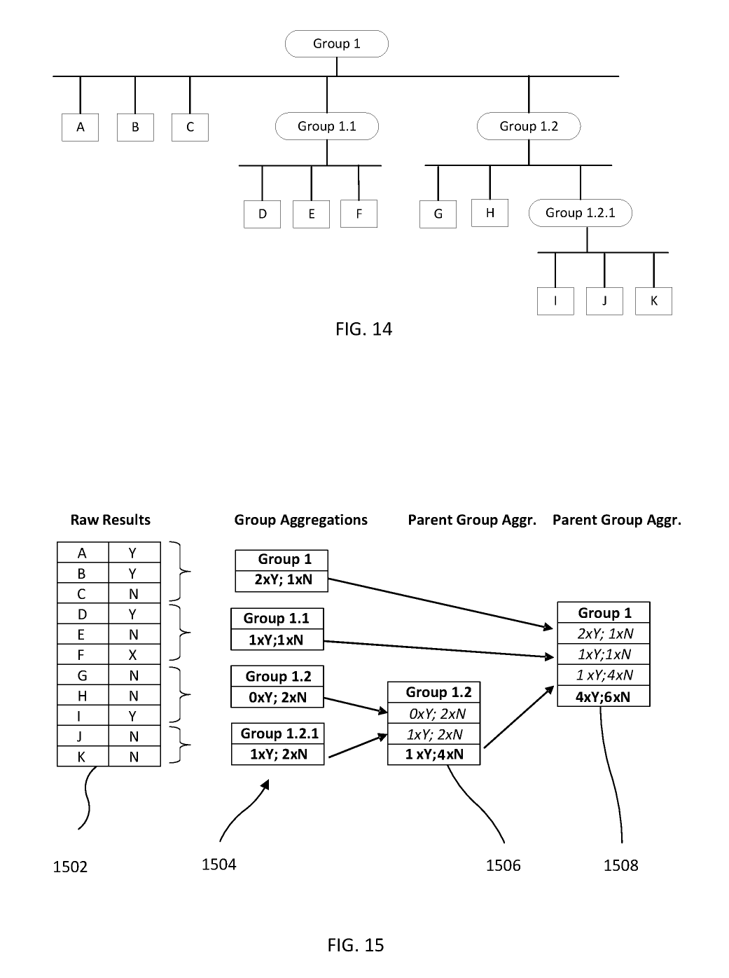

A simple example of response aggregation will be described with reference to FIGS. 14 and 15. FIG. 14 shows a hierarchical group structure for users A to K, used for addressing and routing messages in group chat for example, as described above. A simple poll query may be sent to these users, by way of a container card such as card 700 of FIG. 7a, in a structured data format with constrained responses of “yes” or “no”. This may be sent by user B for example, addressed to group 1. Grouping and routing is arranged so that the message is delivered to all users A to K, by virtue of downwards cascading.

FIG. 15 shows the raw data of individual responses entered by each of the users in table 1502. It can be seen that each user has entered either yes (Y) or no (N) apart from user F who has not replied (but may do so later). A first set of group aggregations are shown at 1504, with the number of yes responses summed and the number of no responses summed for each group. Summing is used in this example, but other logic and functions such as mean and median could be used in other cases. Metadata defining logic and functions for the container card may be created when the card is created. A parent group aggregation is shown at 1506 for Group 1.2. The constituent group aggregations making up Group 1.2 (based on the hierarchical group structure of FIG. 14) are collated and summed to provide a parent group aggregation. A second, higher tier parent group aggregation is shown at 1508, in which the group aggregations for Groups 1, 1.1, and 1.2 (again based on the hierarchical group structure of FIG. 14) are collated and summed, to provide a top level group aggregation of 4 “yes” responses and 6 “no” responses. This may be displayed to a user, such as user B who created the poll, in a format defined by the container card such as 720 in FIG. 7b.

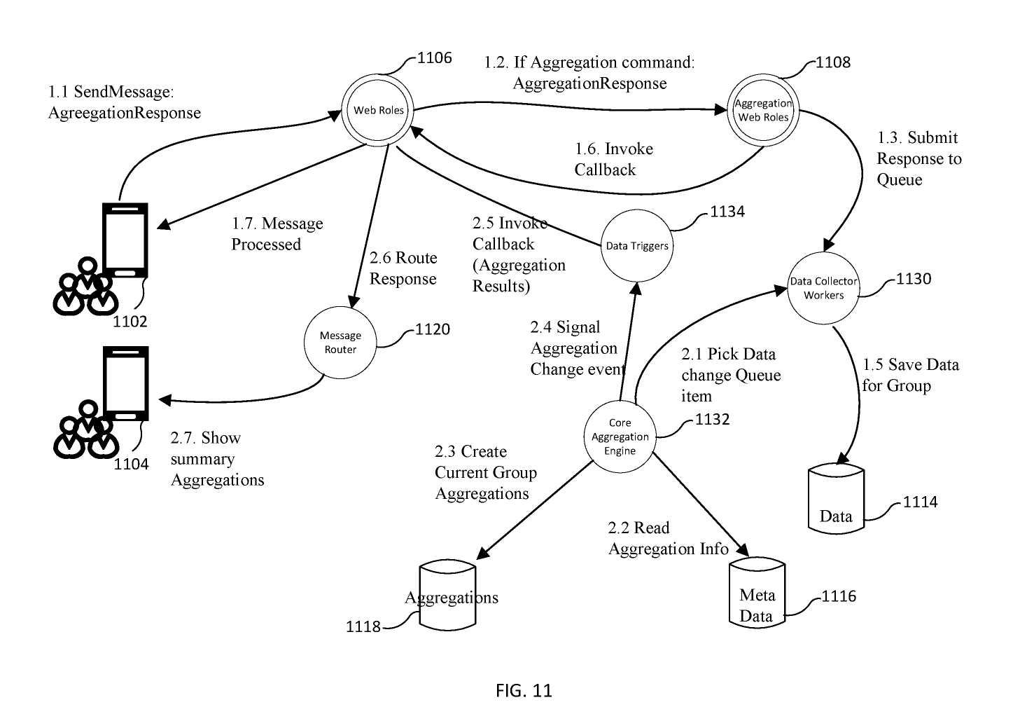

FIG. 9 shows an example of the basic components providing an instant messaging service. In FIG. 9, a cloud server or cloud computing platform is used instead of a dedicated server or servers. In the cloud platform, multiple cloud service roles, comprising a collection of virtual machines, working together to perform tasks under the management of a controller.

A plurality of client terminals 902 connect to the cloud platform via multiple web role instances 904. A load balancer may be provided to balance the load. The web role instances can create jobs, which are passed to job queue pool 906. Jobs in the job queue pool can be picked and processed by worker roles 908. Persistence workers 910 may also be provided for archiving messages in permanent user store 912. The web roles and worker roles have access to group data 914 which stores the grouping structure of users.

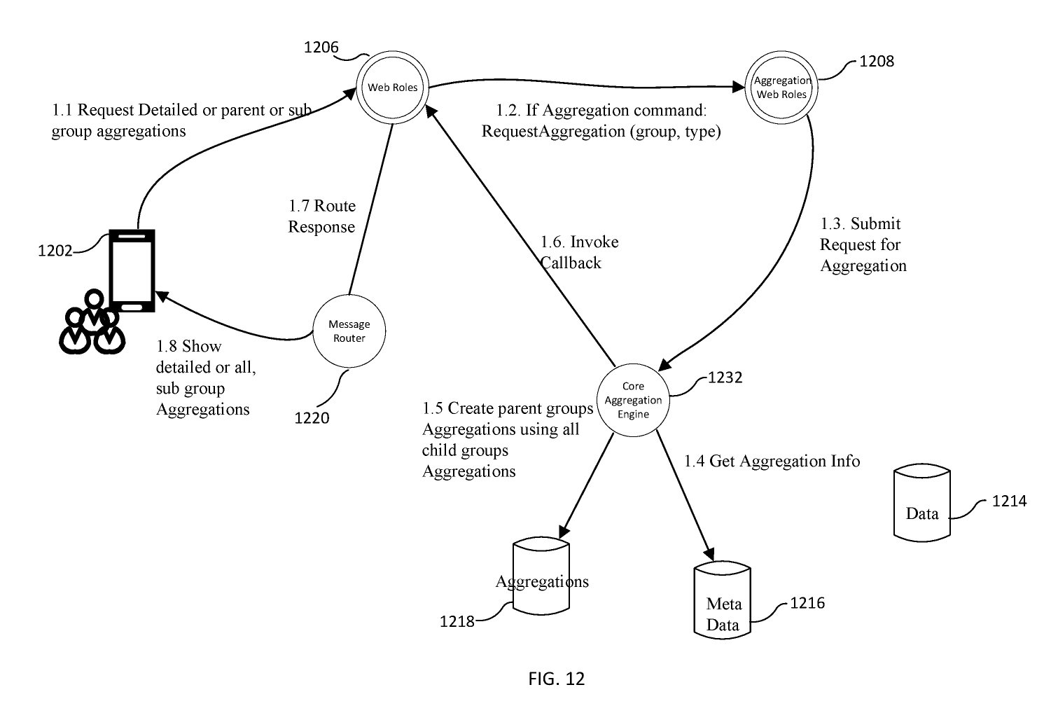

FIGS. 10 to 12 show data flows associated with a container card polling example.

Referring to FIG. 10, a user creates an aggregator container card at terminal 1002 which results in a create aggregator command message 1.1 being set to a server represented by web roles 1006. A separate aggregation web role(s) 1008 is provided to handle aggregation functions and if the create aggregator message is detected it is forwarded at 1.2 to the aggregation web role for processing. At 1.3 metainfo or metadata is created and sent to data manager 1012. The metadata defines the properties of the aggregation container card.

At 1.4.1 raw data tables are created by the data manager to store the raw data 1014 responses from users, such as the responses 1502 of FIG. 15. At 1.4.2 the aggregations metadata 1016 is stored by the data manager. This is metadata which defines the poll query, for example in terms of the structure, answer options and logic to control aggregation of responses, such as summing or averaging responses. Aggregation tables 1018 are created by the data manager at 1.4.3 to store aggregated data by group, such as aggregated data 1504 of FIG. 15. Such aggregated data may be based on the raw data and aggregations metadata for example, as will be described in more detail below.

At 1.5, a callback is invoked to the web role (which may be a different instance to that described in relation to 1.1 and 1.2) and this in turn sends a confirmation 1.6 to user terminal 1002. The confirmation indicates that the aggregation poll request has been completed and is ready to be issued. At 2.1 the user posts or sends the poll request. The request may be sent to individual addressees or to a group or groups. A web role 1006 routes the request at 2.2 via message router 1020 resulting in the aggregation request being distributed 2.3 to one or more user devices 1004. The message router 1020 may include or have access to a hierarchical group addressing structure, such as the structure of FIG. 5 or 14 for example, and can resolve addresses of intended recipients based on group information.

FIG. 11 illustrates flow processing of a user sending a response to the polling request. At 1.1 a recipient of a polling request 1102 sends a response, including the information input by the user, such as a selection from a set of predefined answers. The response is received by web roles 1106 and if the submit response type is detected it is forwarded 1.2 to aggregation web roles 1108 for processing. The aggregation web roles submit the response as a job to a queue at 1.3, and the job is processed by a data collection worker role 1130. The data collection worker saves the user data from the response to raw data table 1114 for storing at 1.5.

Once the data is stored, the aggregation web role invokes a callback 1.6 to web roles 1106, which in turns confirms at 1.7 to the user device 1102 that the response is processed. It is noted that by keeping the processing of the data collection worker simple (aggregation function are handled separately by core aggregation engine 1132 described below), very large numbers of responses, and acknowledgment of responses can be handled efficiently.

Separately, a core aggregation engine 1132 picks a data change queue item from the data collection worker at 2.1 and reads 2.2 the aggregation information from the meta data store 1116, which defines how data is to be aggregated. Core aggregation engine also has access to group information used by message router 1120. Based on this information, the core aggregation engine is able to populate or update 2.3 the group aggregation data stored at 1118, to reflect the user response represented by the data change queue item. Once the group aggregation data is populated or created, an aggregation change event signal 2.4 is generated to data triggers 1134. This in turn invokes a callback 2.5 to web roles 1106, where an aggregation summary response can be sent via message router 1120, to a user device 1104, as shown by 2.6 and 2.7. The user receiving the aggregation summary response may be the user who created the aggregation poll request, or another user who has requested aggregated results.

The aggregation summary response may appear as a message at the user device 1104, in the form of a container card such as 720 of FIG. 7b, in a chat display as shown in FIG. 8 for example. However, if such a container card is already displayed, the aggregation summary response may simply update the container card with updated data.

FIG. 12 show a process flow for a user requesting aggregated data. At 1.1, a request from a user device 1202 is sent including information of a parent or child group for which aggregated data is desired. Alternatively, the level of aggregation to be returned could be defined by default, based on the group or groups of which that user is a member. For example, only data from groups at the same level or below may be available. The request is received at web roles 1206, and if the request aggregation type message is detected, the request is passed at 1.2 to aggregation web roles 1208. A request for aggregation 1.3 is sent to the core aggregation engine 1232, which retrieves 1.4 aggregation information from meta data store 1216. At the same time the core aggregation engine has access to the grouping information used by router 1220. Based on this information the aggregation engine is able to create at 1.5 parent group aggregations (such as 1506, 1508 of FIG. 15) using aggregations already existing for constituent child groups, which are stored in aggregations data 1218. It is noted that stored raw data 1214 is illustrated, but that in some examples parent group aggregations can be created without reference to such raw data.

It should be noted that the creation of parent group aggregations is described here in relation to a specific request, however parent group aggregations may be performed automatically, in preparation for any possible request for example.

The core aggregation engine then invokes a callback 1.6 to web roles 1206 including information of the created parent aggregated data. Web roles 1206 subsequently route a response 1.7, via message router 1220 user device 1202, to show the aggregated information requested, preferably as a container card.

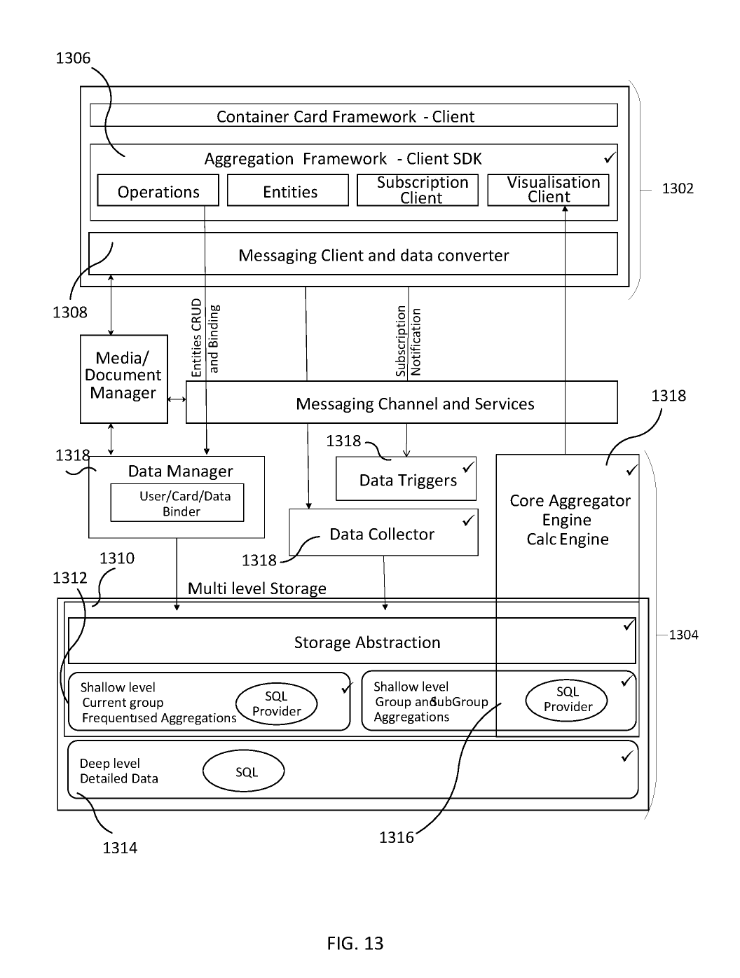

FIG. 13 shows an example framework architecture capable of performing the processing flow described in FIGS. 10 to 12. Elements grouped as 1302 are embodied at the client side, on a user terminal device, while elements grouped as 1304 are embodied at a server or servers, such as a cloud server for example. In between the two are messaging channel and services for passing data between the two, and a media/document manager if required for media exchanges.

At the client side a container card framework includes an aggregation framework 1306 including a set of APIs for: operations, entities, subscription client and visualisation client. The operation API handles operations to entities, of creation, reading, updating and deleting (CRUD) and also binding, communicating with the data manager 1318 at the server side. The entities API handles the data entities, in communication with the data collector 1318. The subscription client handles subscription and notifications in communication with the data triggers module 1318, and can receive data from the server and manipulate it into a prescribed container card format. The visualisation client creates the view or set of views at the client based on data received from the core aggregator engine 1318. Messaging client and data converter handles traffic sent to and received from the messaging channel.

Multi level storage 1310 is provided at the server, here using SQL database, but other storage types are possible using storage abstraction. Deep level storage 1314 includes the raw data such as 1014, 1114, 1214 of FIGS. 10-12 from each of the user responses to a poll query, while shallow level storage 1312 and 1316 stores data aggregated by group, as provided by core aggregator calculation engine 1318, such as aggregations data 1018, 1118, 1218 of FIGS. 10-12.

The core aggregator engine 1318 has access to the multi level storage, to retrieve deep level data for example, but also has access to grouping information defining membership of groups, and hierarchical relationships between groups, primarily used for routing purposes, such as group data 914 of FIG. 9.

It will be understood that the present invention has been described above purely by way of example, and modification of detail can be made within the scope of the invention. Each feature disclosed in the description, and (where appropriate) the claims and drawings may be provided independently or in any appropriate combination.

The various illustrative logical blocks, functional blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the function or functions described herein, optionally in combination with instructions stored in a memory or storage medium. A processor may also be implemented as a one or a combination of computing devices, e.g., a combination of a DSP and a microprocessor, or a plurality of microprocessors for example. Conversely, separately described functional blocks or modules may be integrated into a single processor. The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, and a CD-ROM.

1. A method comprising:
distributing a structured data format message to a plurality of users of a communications service, according to a hierarchical group addressing structure into which said users are arranged;
receiving a plurality of responses to said message from at least some of said plurality of users, said responses including information input by the respective users according to said structured data format;
aggregating said information using said hierarchical group addressing structure; and
outputting said aggregated information to at least one user of the communications service.

2. A method according to claim 1, further comprising receiving said structured data format message from a first user of the communication service, said message being addressed to at least one group of said hierarchical group addressing structure.

3. A method according to claim 2, wherein distributing said structured data format message comprises determining all child groups which are subordinate in said hierarchical structure to the or each group to which said structured data format message is addressed; and
routing said message to all members of groups to which said message is addressed, and all determined child groups.

4. A method according to claim 1, wherein aggregating said information comprises collating, in each group in the hierarchical group addressing structure, information contained in responses from individual users in that group.

5. A method according to claim 1, wherein aggregating said information comprises further collating, for each group in the hierarchical group addressing structure, information contained in responses from all child groups subordinate to that group.

6. A method according to claim 2, wherein said aggregated information is output to said first user.

7. A method according to claim 2, further comprising receiving a request for aggregated information from a user of the communication service, said request indicating a target group or groups, and outputting aggregated information corresponding to information contained in responses from said target group or groups to said user.

8. A method according to claim 2, further comprising receiving a request for aggregated information from a user of the communication service, and outputting aggregated information corresponding to information contained in responses from the group to which said user belongs, and all child groups subordinate to that group.

9. A method according to claim 1, wherein said output is provided as a message in the structured data format.

10. A method according to claim 9, further comprising updating said message.

11. A method according to claim 1, wherein said hierarchical group addressing structure includes at least a first group of users and a second group of users, said second group being a member of said first group, such that messages addressed to the first group are routed also to the second group.

12. A method according to claim 11, wherein messages addressed to the second group are not routed to the first group.

13. A communications system comprising:
one or more messaging servers;
one or more user terminal devices in communication with said one or more messaging servers;
a directory storing group information of groups used to route messages to multiple users, wherein said directory includes at least one child group which is a member of another parent group;
a data store, containing data representing user input to messages at said terminal devices and sent over said communications system;
an aggregation engine adapted to aggregate data stored in said data store according to group information stored in said directory;
wherein said one or more messaging servers is adapted to route messages to terminal devices based on said group information, and to forward aggregated data output by said aggregation engine to at least one terminal device.

14. A communications system according to claim 13, wherein said one or more messaging servers is adapted to route messages addressed a parent group also to a child group.

15. A communications system according to claim 13, wherein said one or more messaging servers is adapted not to route messages addressed a child group to a corresponding parent group.

16. A computer readable storage medium comprising computer readable instructions which when run on a computer cause that computer to perform the following steps:
distributing a structured data format message to a plurality of users of a communications service, according to a hierarchical group addressing structure into which said users are arranged;
receiving a plurality of responses to said message from at least some of said plurality of users, said responses including information input by the respective users according to said structured data format;
aggregating said information using said hierarchical group addressing structure; and
outputting said aggregated information to at least one user of the communications service.

17. A computer readable storage medium according to claim 16, the steps further comprising receiving said structured data format message from a first user of the communication service, said message being addressed to at least one group of said hierarchical group addressing structure.

18. A computer readable storage medium according to claim 17, wherein distributing said structured data format message comprises determining all child groups which are subordinate in said hierarchical structure to the or each group to which said structured data format message is addressed; and
routing said message to all members of groups to which said message is addressed, and all determined child groups.

19. A computer readable storage medium according to claim 16, wherein aggregating said information comprises collating, in each group in the hierarchical group addressing structure, information contained in responses from individual users in that group.

20. A computer readable storage medium according to claim 16, wherein aggregating said information comprises further collating, for each group in the hierarchical group addressing structure, information contained in responses from all child groups subordinate to that group.
